(19) United States
(12) Patent Application Publication
(10) Pub. No.: US 2006/0220823 A1
(43) Pub. Date: Oct. 5, 2006

(54) Safety switch for motor vehicle

(76) Inventors: James W. Armstrong, Dayton, PA (US); Lowell J. Dean, Dayton, PA (US)

Correspondence Address: JAMES R. WILLIAMS, 3103 WILMINGTON ROAD, NEW CASTLE, PA, 16105, US

(21) Appl. No.: 11/390,573

(22) Filed: Mar. 28, 2006

Related U.S. Application Data
(60) Provisional application No. 60/667,569, filed on Apr. 1, 2005.

(51) Int. Cl. B60Q 1/26

(52) U.S. Cl. 340/468; 340/471; 340/475

(57) ABSTRACT

A switch assembly automatically turns on and off a hazard light on a motor vehicle in concert with a turn signal of the vehicle. Activating the turn signal interrupts power to the hazard light so that other vehicles are not distracted by it. The switch assembly detects activation of the turn signal and simultaneously turns off power to the hazard light. The assembly then turns on the hazard light after the turn is completed. The assembly includes a switch and a relay. The switch detects activation of the turn signal, and transmits that information to the relay. The relay interrupts power to the hazard light when the signal is activated.

### CROSS-REFERENCE TO RELATED APPLICATIONS

This application is based upon and claims priority of U.S. Provisional Application No. 60/667,569 filed Apr. 1, 2005, which is hereby incorporated by reference.

### FIELD OF THE INVENTION

The invention describes a safety switch for use in vehicles equipped with both turn signals and a hazard light. The safety switch turns off the hazard light when a turn signal is engaged.

### BACKGROUND

Rural mail carriers frequently do not use government or marked vehicles in the execution of their duties. Instead, rural carriers typically use their own private, unmarked vehicles. Safety regulations require such a vehicle to display a flashing yellow hazard light on its roof while delivering mail.

Ironically, the flashing yellow hazard light has been cited as the cause for many accidents. A typical scenario includes a following vehicle attempting to pass the rural carrier when carrier is attempting a left hand turn. The driver of the following vehicle is distracted by the flashing yellow light and fails to notice the turn signal of the rural carrier.

The U.S. Postal Service has issued regulations that require all rural mail carriers using a vehicle with a flashing yellow hazard light to disable or turn off the flashing hazard light while signalling or making left hand turns. The rural carrier must now turn off the flashing light, signal for the turn, execute the turn, and turn back on the flashing light. Not surprisingly, rural carriers often neglect to turn off the light or, if they do turn it off, they forget to turn it back on.

Prior art includes circuits that automatically engage hazard lights or safety apparatus in the event of an emergency. For example, U.S. Pat. No. 6,879,251 to Robbins et al. teaches an apparatus that automatically actuates a hazard light in response to an electrical input signal generated within the vehicle's safety system. The vehicle is provided with a safety system generating an electrical input signal in response to a triggering event, and an electric switch that closes a by-pass circuit in response to the input signal, whereby the hazard light is activated. Such prior art systems are not directed to the problems associated with turning off a hazard light nor are they responsive to activation of a turn signal.

An object of this invention is to automate switching of the hazard light when an operator puts on a turn signal. The invention automatically turns off the hazard light when a turn signal is engaged and turns on the hazard light when the turn signal is disengaged.

### BRIEF DESCRIPTION OF THE INVENTION

The present invention includes a switch that responds to activation of a vehicle's turn signal. The switch includes “open” and “closed” positions. The position of the switch controls the transmission of power to the flashing hazard light. Turning on the vehicle's turn signal automatically opens the electrical circuit to the flashing hazard light and switches off the light. Turning off the vehicle's turn signal automatically causes the circuit to close and switches on the flashing hazard light. The invention may be used to activate or deactivate an electrical device when a turn signal is activated. Conveniently, the invention may be mated to the left turn signal of a motor vehicle so that upon activation of the left turn signal a hazard light will go off and remain off until the left hand turn signal is disengaged. This embodiment complies with current U.S. Postal Service regulations for rural carriers.

### BRIEF DESCRIPTION OF THE DRAWING

FIG. 1 shows a schematic of one embodiment of the present invention.

### DESCRIPTION OF THE INVENTION

The present invention relates to a circuit that automates the process of turning on and off an electrical appliance on a vehicle during the execution of a turn. Typically, the electrical appliance comprises a flashing hazard light. The vehicle includes a turn signal stock that is moved from a neutral position to activate a turn signal light. Moving the stock activates a switch. The switch is electrically connected to a relay that controls power to the electrical appliance. The relay interrupts power to the light when the switch activates. Moving the stock back to the neutral position deactivates the switch and returns power to the hazard light.

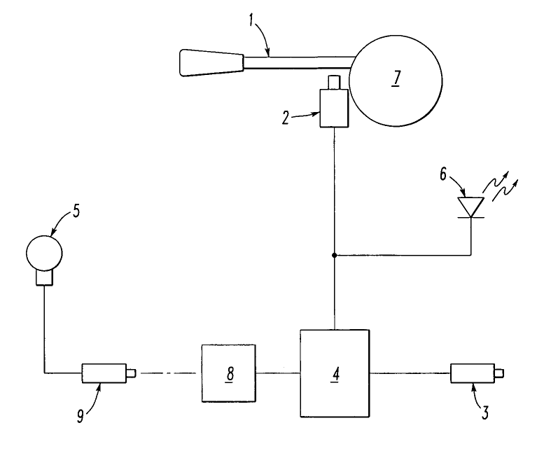

FIG. 1 shows a schematic diagram of one embodiment of the invention. The vehicle (not shown) includes a turn signal stock 1 attached to a steering column 7. A button-type switch 2 is mounted on the vehicle so that depression of the turn signal stock 1, so as to turn on the left turn signal, will depress the switch 1. The switch 1 is part of an electrical circuit comprising a power source 3, a relay 4, and the flashing hazard light 5. The switch 2 includes an “on” position and an “off” position. In the “on” position, the switch permits power to flow to the hazard light 5. The “off” position signals the relay 4 to prevent power from flowing to the hazard light 5 and effectively turns off the light 5. An indicator 6 may be included to show the status of the switch. Conveniently, the indicator 6 may be an LED. The LED may be a two-color diode where the colors indicate the status of the hazard light 5. For example, the LED may shine green when the hazard light 5 is on and red when the hazard light 5 is off.

In the illustrated embodiment, the hazard light 5 plugs into a power receptacle 8. The relay 4 directs electricity to the power receptacle 8 based on the position of the turn signal stock 1. The relay 4 interrupts electric current when the left turn signal stock is depressed and returns electric current to the power receptacle 8 when the stock is returned to its neutral position. The hazard light 5 may receive electrical current by inserting the plug 9 into a power receptacle 8. This embodiment permits the hazard light 5 to be removed from the motor vehicle. Alternatively, the hazard light could be wired into the vehicle's circuitry.

The embodiment of FIG. 1 operates by pushing down the turn signal stock to activate the left turn signal. The stock depresses the switch and places the switch in the “off” position. In response to the switch, the relay opens the electrical circuit thereby interrupting power to the hazard light so long as the switch remains in the “off” position. When the turn signal stock is raised, the switch returns to the “on” position and the relay closes the electrical circuit thereby restoring power to the hazard light. The switch of this embodiment may be of any type that returns to the “on” position when the turn signal stock is raised.

The safety switch may be any convenient type known to one skilled in the art, such as a simple mechanical contact, a magnetic reed, etc. The switch may even be integrated into the circuitry of the turn signal itself, whereby the same circuitry that activates the turn signal deactivates the hazard light. The switch may be mounted either internally or externally on the steering column 7. External mounting is convenient in after-market installations.

The relay comprises electrical or electronic circuitry that responds to the signal from the switch. One skilled in the art would appreciate a number of circuits that would be suitable for the application. The relay may even be combined into the same physical unit as the switch. The relay may comprise delay or timer circuitry that further controls electric current to the electrical appliance.

Conveniently, the electrical circuit includes a by-pass feature that disengages the switching mechanism when not needed. For example, the by-pass provides continuous electrical current to the power receptacle when the hazard light or electrical appliance is not in use.

The electrical appliance may be any device that externally plugs into a power receptacle 8 of the vehicle. A flashing hazard light is commonly used, but the electrical safety switch will operate on any electrical appliance plugged into the power receptacle 8.

### Example 1

One embodiment of the present invention includes a switch that requires contact with the turn signal stock to activate. The switch is in electrical contact with the hazard light, a 12-volt relay, and a power source. The switch comprises a magnetic reed switch mounted under the turn signal stock. The stock has a magnet that engages the reed switch when the stock is depressed to indicate a left turn. The switch triggers the relay to go from a normally closed electrical circuit to an open circuit. The open circuit prevents power from reaching the hazard light and effectively shuts off the hazard light. Raising the turn signal stock disengages the magnet and the reed switch. The relay then returns to the normally closed electrical circuit and the hazard light is turned on.

### Example 2

A second embodiment includes a relay electrically communicating with the electrical circuit of the turn signal. The relay directs power to the hazard light and is able to determine when the turn signal circuit is on. Upon detecting that the turn signal circuit is on, the relay opens the electrical circuit to the hazard light so that the hazard light switches off. Advantageously, this embodiment does not rely on a mechanical switch.

### Example 3

A third embodiment includes a timer circuit capable of receiving an electrical signal from the left turn signal circuit. The timer circuit interrupts power to the hazard light when detecting such a signal and directs the relay to shut off power to the hazard light. The timer interrupts power to the hazard light for a period of time sufficient to execute the turn.

Obviously, numerous modifications and variations of the present invention are possible. It is, therefore, to be understood that within the scope of the following claims, the invention may be practiced otherwise than as specifically described.

What is claimed is:

1. A switch assembly for a motor vehicle, the assembly comprising a switch in electrical communication with a relay that controls electrical current to an electrical device, the switch being capable of determining when a turn signal of the vehicle has been activated and signaling the relay to interrupt electrical current to the electrical device, the switch also capable of determining when the turn signal has been deactivated and signaling the relay to restore electrical current to the electrical device.

2. The switch of claim 1, wherein the switch is selected from a group consisting of a simple mechanical contact and a magnetic reed switch.

3. The switch of claim 1, wherein the turn signal is activated by depression of a turn signal stock, and the depression of the turn signal stock triggers the switch to signal the relay to interrupt electrical current to the electrical device.

4. The switch of claim 1, wherein the relay includes a time-delay device that delays restoration of electrical current to the electrical device.

5. The switch of claim 1, wherein the electrical device is selected from a group consisting of a power receptacle and a hazard light.

6. The switch of claim 1, wherein the assembly includes a by-pass circuit that, when activated, is capable of maintaining electrical current to the electrical device.

7. An electrical circuit for a motor vehicle having a turn signal, the circuit comprising a switch, a relay and a hazard light, the switch capable of determining when the turn signal has been activated and signaling the relay to interrupt electric power to the hazard light, the switch also capable of determining when the turn signal has been deactivated and signaling the relay to restore electric power to the hazard light.

8. The electrical circuit of claim 7, wherein the circuit includes a timer that delays restoration of electric power to the hazard light for a predetermined period of time.

9. The electrical circuit of claim 7, wherein the hazard light plugs into a power receptacle.
